(19) United States
(12) Patent Application Publication
(10) Pub. No.: US 2021/0101354 A1
(43) Pub. Date: Apr. 8, 2021

(54) CARDBOARD BOX ASSEMBLY DEVICE

(71) Applicant: ISHIDA CO., LTD., Kyoto-shi (JP)

(72) Inventors: Tatsuya IWASA, Ritto-shi (JP); Satoshi NISHITSUJI, Ritto-shi (JP); Tatsuya ARIMATSU, Ritto-shi (JP); Satoshi TATSUKAWA, Ritto-shi (JP)

(73) Assignee: Ishida Co., Ltd.

(21) Appl. No.: 17/033,956

(22) Filed: Sep. 28, 2020

(30) Foreign Application Priority Data
Oct. 2, 2019 (JP) 2019-182105

(51) Int. Cl. B31B 50/00; B31B 50/16

(52) U.S. Cl. CPC B31B 50/006; B31B 50/16

(57) ABSTRACT

A cardboard box assembly device, that folds four flaps provided at edges of an opening in a cardboard box to surround the opening, is disclosed. The cardboard box assembly device includes a folding unit, a pushing unit, and a drive unit. The folding unit folds each of the four flaps in a prescribed sequence and closes the opening. The pushing unit pushes one of the four flaps, that is folded last, inward into the cardboard box as a locking flap, and overlaps the locking flap onto the other flaps. The drive unit contacts the cardboard box and imparts a prescribed displacement to the cardboard box. Parts that engage with one another are formed between the locking flap and at least one of the other flaps. The drive unit moves the locking flap relative to the other flaps due to the displacement when the pushing unit pushes the locking flap.

### CROSS-REFERENCE TO RELATED APPLICATIONS

This application claims priority to Japanese Patent Application No. 2019-182105, filed Oct. 2, 2019. The contents of that application are incorporated by reference herein in their entirety.

### TECHNICAL FIELD

The present invention relates to a cardboard box assembly device.

### BACKGROUND ART

In recent years, cardboard boxes of which bottoms are able to be easily assembled have proliferated, and devices that assemble such cardboard boxes have become widespread. For example, when assembling a bottom face of a packaging box, the assembly device for packaging boxes described in Japanese Laid-open Patent Publication No. 2012-162271, assembles the bottom face by first folding a first bottom face piece, then folding a third bottom face piece and a fourth bottom face piece that are mutually opposite to one another, and lastly, folding a second bottom face piece that is opposite to the first bottom face piece and engaging a recess in the first bottom face piece and a projection in the second bottom face piece with one another.

### BRIEF SUMMARY

However, when the second bottom face piece is pushed inside the packaging box and the projection is engaged with the recess in the first bottom face piece, if positions of the recess and the projection are offset from normal positions, such offset leads to an issue where the recess and the projection do not engage with one another.

An object of the present invention is to provide a cardboard box assembly device with which flaps in a mutually engaging relationship can be engaged with one another in an appropriate manner even when positions of the flaps are offset from normal positions.

A cardboard box assembly device according to a first aspect of the present invention folds four flaps that are provided at edges of an opening in a cardboard box so as to surround the opening. The cardboard box assembly device comprises a folding unit, a pushing unit, and a drive unit. The folding unit folds each of the four flaps in a prescribed sequence and closes the opening. The pushing unit pushes a locking flap that is folded last out of the four flaps inward into the cardboard box, and overlaps the locking flap onto the other flaps. The drive unit makes contact with the cardboard box and imparts a prescribed displacement to the cardboard box. Parts that mutually engage with one another are formed between the locking flap and at least one of the other flaps. The drive unit moves the locking flap relative to the other flaps due to the displacement when the pushing unit pushes in the locking flap.

Herein, “when the pushing unit pushes in the locking flap” encompasses times when the pushing unit is performing an operation to push in the locking flap, and times when the pushing unit is maintaining a state in which the locking flap has been pushed in.

In this cardboard box assembly device, the locking flap is pushed inward beyond a plane of the opening, and the locking flap overlaps and engages with the other flaps. When this occurs, even if engagement positions are offset, because the drive unit imparts a prescribed displacement to the cardboard box whereby the locking flap moves relative to the other flaps, positional offset is eliminated, and the locking flap and the other flaps engage with one another in an appropriate manner.

A cardboard box assembly device according to a second aspect of the present invention is the cardboard box assembly device according to the first aspect, wherein the locking flap and the other flaps move relative to one another along a direction intersecting a direction in which the locking flap is pushed.

In this cardboard box assembly device, because the locking flap is in a positional relationship with the other flaps so as to engage therewith when pushed, engagement is likely to be inhibited due to the positional offset in the direction intersecting the direction of pushing. Moving the locking flap and the other flaps relative to one another along the direction intersecting the direction in which the locking flap is pushed is thus effective in eliminating positional offset of the engagement positions.

A cardboard box assembly device according to a third aspect of the present invention is the cardboard box assembly device according to the first aspect or the second aspect, wherein the drive unit makes contact with at least one of the flaps other than the locking flap, or with a side face of the cardboard box, and imparts the displacement to the cardboard box.

In this cardboard box assembly device, the drive unit makes contact with a flap or a side face of the cardboard box and displaces the cardboard box, whereby a shape of the opening in plan view is able to be distorted, and as a result, the locking flap and the other flaps can be moved relative to one another along the direction intersecting the direction in which the locking flap is pushed.

A cardboard box assembly device according to a fourth aspect of the present invention is the cardboard box assembly device according to any one of the first aspect to the third aspect, further comprising a holding unit. The holding unit holds and moves the cardboard box when the cardboard box is conveyed. The holding unit doubles as the drive unit.

In this cardboard box assembly device, when the pushing unit pushes in the locking flap, the holding unit moves the cardboard box along a direction of conveyance, whereby the other flaps moves relative to the locking flap, the movement of which is restricted by the pushing unit.

A cardboard box assembly device according to a fifth aspect of the present invention is the cardboard box assembly device according to the second aspect, wherein the pushing unit imparts a displacement to the locking flap along the direction intersecting the direction in which the locking flap is pushed.

In this cardboard box assembly device, rather than the drive unit imparting a displacement to the cardboard box, the pushing unit imparts a displacement to the locking flap in the direction intersecting the direction in which the locking flap is pushed while the drive unit remains stationary, whereby the locking flap moves relative to the other flaps.

A cardboard box assembly device according to a sixth aspect of the present invention is the cardboard box assembly device according to any one of the first aspect to the fourth aspect, wherein after imparting a first displacement that deforms a shape of the opening of the cardboard box in plan view into a parallelogram shape, the drive unit imparts a second displacement that restores the opening to an original shape thereof.

In this cardboard box assembly device, the cardboard box is displaced and the shape of the opening in plan view is distorted into a parallelogram shape, whereby the locking flap and the other flaps can be moved relative to one another along the direction intersecting the direction in which the locking flap is pushed.

A cardboard box assembly device according to a seventh aspect of the present invention is the cardboard box assembly device according to any one of the first aspect to the sixth aspect, wherein of the four flaps, a flap opposing the locking flap has a first part that is cut out into a recessed shape. The locking flap has a protruding second part that can be inserted into the first part. When the pushing unit pushes in the locking flap, the second part is overlapped onto the first part.

In this cardboard box assembly device, the second part is overlapped onto the first part, whereby the second part and the first part engage with one another, and even if offset were to arise at a position where the second part and the first part overlap, when the pushing unit pushes in the locking flap, the locking flap and the other flaps move relative to one another due to the prescribed displacement imparted by the drive unit, and the second part and the first part engage with one another.

In the cardboard box assembly device according to the present invention, the locking flap is pushed inward beyond the plane of the opening, and the locking flap overlaps and engages with the other flaps. When this occurs, even if engagement positions are offset, because the drive unit imparts a prescribed displacement to the cardboard box whereby the locking flap moves relative to the other flaps, positional offset is eliminated, and the locking flap and the other flaps engage with one another in an appropriate manner.

### BRIEF DESCRIPTION OF THE DRAWINGS

FIG. 1 is a block diagram of a box-packing system equipped with a cardboard box assembly device according to an embodiment of the present invention.

FIG. 2A is a perspective view illustrating configuration of the box-packing system.

FIG. 2B is a perspective view illustrating a flow of cardboard boxes and goods in the box-packing system.

FIG. 3A is a perspective view of a cardboard box precursor that has been expanded into a tubular shape before folding bottom flaps thereof.

FIG. 3B is a perspective view displaying, in three stages, a process for folding the bottom flaps in FIG. 3A.

FIG. 4 is a perspective view of relevant parts of a case-forming section.

FIG. 5 is a schematic side view of a first folding mechanism and a third folding mechanism.

FIG. 6 is a side view of a suction pad immediately before the suction pad strikes a large locking flap.

FIG. 7 is a side view of the suction pad when the suction pad has struck the large locking flap and pushed in the large locking flap.

FIG. 8 is a flowchart of operation of the case-forming section.

FIG. 9 is a side view of a cardboard box after a large leading flap has been folded and immediately before small flaps are folded.

FIG. 10 is a side view of a cardboard box after small flaps have been folded.

FIG. 11 is a front view of a cardboard box when a third folding plate has folded a large locking flap and a head has been raised.

FIG. 12 is a perspective view of a cardboard box when a large locking flap has been pushed inside the cardboard box.

FIG. 13A is a perspective view of a cardboard box after a large locking flap has been pushed inside the cardboard box but before a large leading flap and the large locking flap move relative to one another.

FIG. 13B is a perspective view of a cardboard box after the large locking flap has been pushed inside the cardboard box and after the large leading flap and the large locking flap move relative to one another.

FIG. 14 is a front view of a cardboard box when the head has been lowered.

FIG. 15A is a side view of a lifting mechanism before dispensing a sheet-form cardboard box precursor upward.

FIG. 15B is an enlarged side view of relevant parts of the lifting mechanism immediately before suction cups adhere to a cardboard box precursor.

FIG. 15C is an enlarged side view of relevant parts of the lifting mechanism immediately after the suction cups have adhered to a cardboard box precursor.

FIG. 16A is a side view of the lifting mechanism after dispensing a sheet-form cardboard box precursor upward.

FIG. 16B is an enlarged side view of an area around suction cups after the suction cups stop adhering after a sheet-form cardboard box precursor has been dispensed upward.

### DETAILED DESCRIPTION

An embodiment of the present invention will be described below with reference to the drawings. Note that the following embodiment is a specific example of the present invention, and does not limit the technical scope of the present invention.

(1) Configuration of Box-Packing System 1

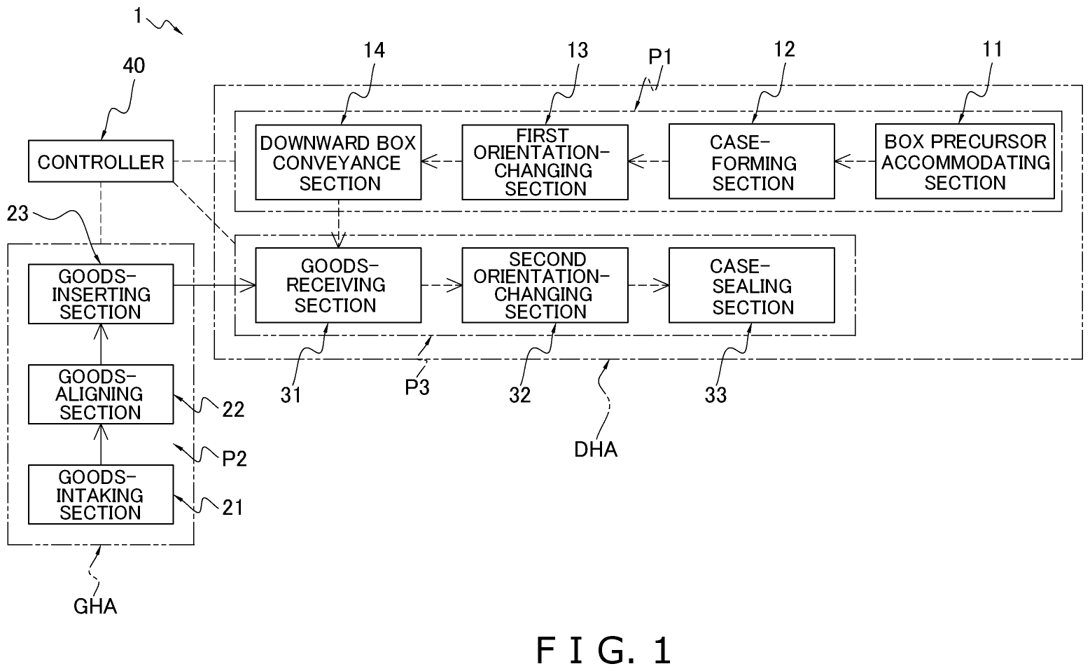

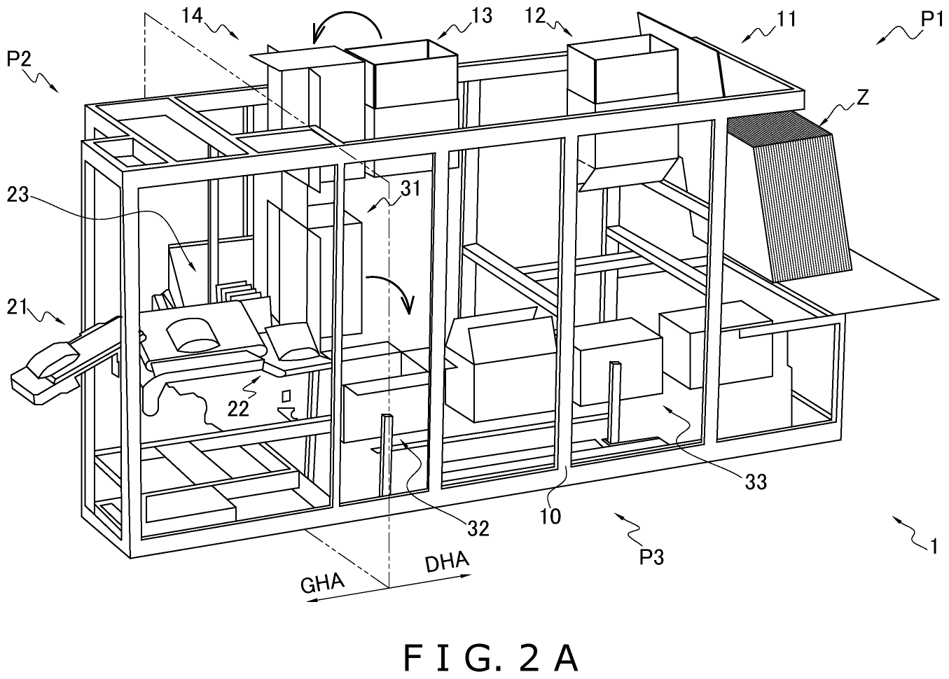

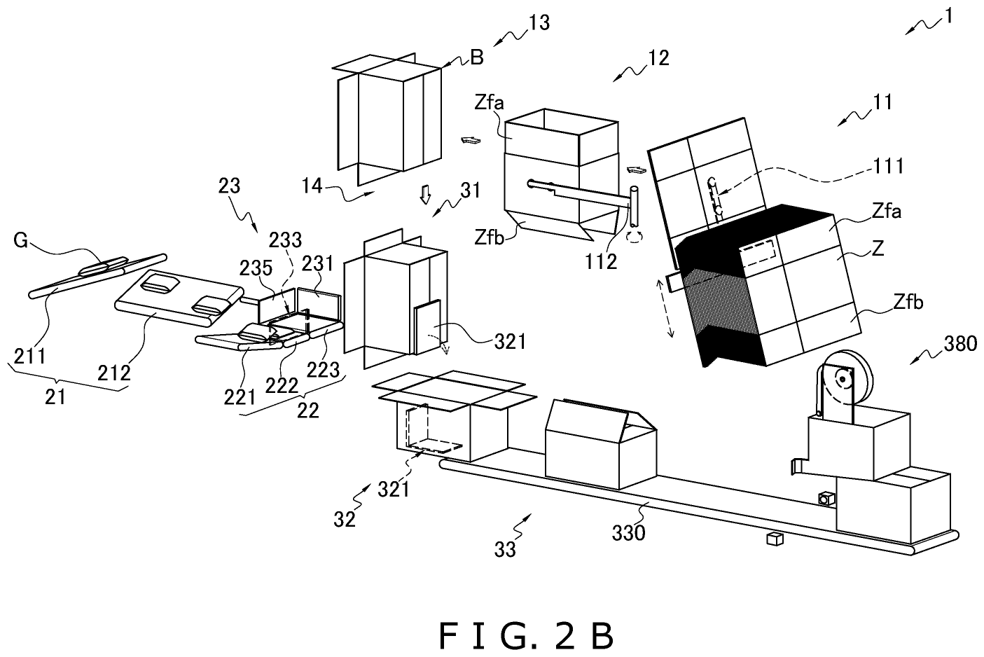

FIG. 1 is a block diagram of a box-packing system 1 equipped with a cardboard box assembly device according to an embodiment of the present invention. FIG. 2A is a perspective view illustrating configuration of the box-packing system 1, and FIG. 2B is a perspective view illustrating a flow of cardboard boxes B and goods G in the box-packing system 1.

The box-packing system 1 in FIGS. 1 and 2A is, for example, a system that packs, in multiple layers, a fixed number of pieces of a bagged good (goods G), such as snack foods, into a cardboard box B in an aligned state.

In the box-packing system 1, as illustrated in FIGS. 1 and 2A, a cardboard handling area DHA and a goods handling area GHA are connected to one another in a state mutually independent of and separable from one another. The cardboard handling area DHA includes two processes: a case-forming process P1 and a box-packing process P3. The goods handling area GHA includes a goods-aligning process P2.

Stated differently, in the box-packing system 1, these three processes, the case-forming process P1, the goods-aligning process P2, and the box-packing process P3, are linked by the connection of the cardboard handling area DHA and the goods handling area GHA.

At the case-forming process P1, sheet-form cardboard box precursors Z are assembled into cardboard boxes B and conveyed to a box-packing position. The case-forming process P1 is configured by a box precursor accommodating section 11, a case-forming section 12, a first orientation-changing section 13, and a downward box conveyance section 14.

At the goods-aligning process P2, goods G supplied from an upstream process are taken in at a prescribed position, a fixed number of goods G are aligned such that adjacent goods G partially overlap with one another, and these goods G are conveyed to a box-packing position. The goods-aligning process P2 is configured by a goods-intaking section 21, a goods-aligning section 22, and a goods-inserting section 23.

At the box-packing process P3, a fixed quantity of goods G that have finished being aligned at the goods-aligning process P2 are packed into cardboard boxes B conveyed from the case-forming process P1, after which the boxes are closed and conveyed to a box-discharge position. The box-packing process P3 is configured by a goods-receiving section 31, a second orientation-changing section 32, and a case-sealing section 33.

The box-packing system 1 packs multiple layers of goods G into a cardboard box B. Inside cardboard boxes B, goods G are oriented in a “standing orientation.” In other words, when an opening in a cardboard box B is facing up, goods G are oriented with front sides and back sides thereof facing sideways, upper and lower ends thereof facing up and down, and left and right sides thereof facing sideways.

As illustrated in FIGS. 2A and 2B, the cardboard box handling area DHA has a bilevel structure. The case-forming process P1 and the box-packing process P3 are supported by a common frame 10. The case-forming process P1 is on a second level of the frame 10, and the box-packing process P3 is on a first level of the frame 10.

To achieve this bilevel structure, a direction of conveyance of cardboard boxes B from assembly of the cardboard boxes B in the case-forming section 12 to the downward box conveyance section 14, and a direction of conveyance of cardboard boxes B until openings in cardboard boxes B packed with goods G are sealed at the case-sealing section 33, are directions that run mutually opposite to one another.

(2) Case-Forming Process P1

As illustrated in FIG. 2B, the case-forming process P1 is configured by the box precursor accommodating section 11 where cardboard box precursors Z are introduced into the box-packing system 1, the case-forming section 12 where cardboard boxes B are assembled, the first orientation-changing section 13 where cardboard boxes B are rotated 90° about a horizontal axis orthogonal to the direction of conveyance thereof, and the downward box conveyance section 14 where cardboard boxes B in a first orientation are conveyed downward.

(2-1) Box Precursor Accommodating Section 11

As illustrated in FIG. 2B, in the box precursor accommodating section 11, a cardboard box precursor Z at the front of cardboard box precursors Z stacked at a supply position are grabbed one-by-one and dispensed upward, where dispensed cardboard box precursors Z are rotated 90° about a vertical axis and expanded into a tubular shape.

Cardboard box precursors Z are placed at the supply position by a worker. The cardboard box precursors Z are flattened in a state in which flaps Zf are open, and are stacked along a horizontal direction oriented such that the flaps Zf are positioned along a vertical direction. To facilitate explanation, top-side flaps Zf are referred to as top flaps Zfa, and bottom-side flaps Zf are referred to as bottom flaps Zfb.

Cardboard box precursors Z are dispensed upward using a lifting mechanism 111, and when all of the cardboard box precursors Z at the supply position have been removed, a detection signal from a detection sensor (not illustrated) is transmitted to a controller 40 (see FIG. 1).

The rotation of cardboard box precursors Z about the vertical axis is achieved using a sucking and rotating mechanism 112. To do so, the sucking and rotating mechanism 112 adheres to a side face of a cardboard box precursor Z with a suction cup and holds the cardboard box precursor Z, and then the sucking and rotating mechanism 112 is rotated 90° about the vertical axis.

(2-2) Case-Forming Section 12

In the case-forming section 12, while a cardboard box precursor Z that has been expanded into a tubular shape is being conveyed along the horizontal direction, the bottom flaps Zfb of the cardboard box precursor Z are folded to form a bottom, and the cardboard box precursor Z is assembled into a cardboard box B with open top flaps Zfa.

The case-forming section 12 configures a cardboard box assembly device according to the invention of present application. This case-forming section 12 will be described in detail under the heading “(5) Detailed configuration of case-forming section 12.”

(2-3) First Orientation-Changing Section 13

In the first orientation-changing section 13, cardboard boxes B are rotated 90° to the direction of conveyance thereof. Described in more detail, in the first orientation-changing section 13, cardboard boxes B are rotated 90° about a horizontal axis orthogonal to the direction of conveyance thereof, and the orientation of the cardboard boxes B is changed such that the opening and the top flaps Zfa of cardboard boxes B lie in the same vertical plane (hereafter referred to as a first orientation). When a cardboard box B is in the first orientation, the opening thereof faces the goods handling area GHA.

(2-4) Downward Box Conveyance Section 14

In the downward box conveyance section 14, cardboard boxes B in the first orientation are conveyed downward. In other words, cardboard boxes B are moved downward in a state in which the openings thereof face the goods handling area GHA.

(3) Goods-Aligning Process P2

A weighing device, a bag-making and packing machine, etc., none of which are illustrated, are disposed upstream of the goods-aligning process P2 in the flow of goods G in the box-packing system 1. In the box-packing system 1, only goods G that have passed weight, sealing, and foreign matter contamination inspections, etc., in an upstream process are supplied to the goods-aligning process P2.

The goods-aligning process P2 is configured by the goods-intaking section 21 where goods G are received and conveyed to a prescribed position, the goods-aligning section 22 where goods G supplied from the goods-intaking section 21 are aligned, and the goods-inserting section 23 where aligned goods G are accumulated and pushed out.

(3-1) Goods-Intaking Section 21

The goods-intaking section 21 has a goods-introducing conveyor 211 and an intake conveyor 212. The goods-introducing conveyor 211 receives, on a downstream side of a process where weight, seal, foreign matter contamination inspections, etc., are performed, a supply of goods G that have passed inspection, and the goods-introducing conveyor 211 guides these goods G to the intake conveyor 212.

The intake conveyor 212 conveys goods G conveyed from the goods-introducing conveyor 211 to the goods-aligning section 22.

(3-2) Goods-Aligning Section 22

The goods-aligning section 22 has a first alignment conveyor 221, a second alignment conveyor 222, and a third alignment conveyor 223. The goods-aligning section 22 conveys goods G to a prescribed position while performing an accumulating operation on the goods G. The goods-aligning section 22 is particularly suited to accumulating bag-form packages, and thus is able to be independently used as a package-accumulating device.

(3-3) Goods-Inserting Section 23

In the goods-inserting section 23, first and last items in a group of goods G aligned in a row on the third alignment conveyor 223 are grabbed, and the entire group of goods G is inserted into a cardboard box B. In order to grab a group of aligned goods G, as illustrated in FIG. 2B, the goods-inserting section 23 has a standing conveyor 231, a push plate 233, and an insertion plate 235.

(4) Box-Packing Process P3

The box-packing process P3 has the goods-receiving section 31 where goods G are received by cardboard boxes B, the second orientation-changing section 32 where the orientation of cardboard boxes B is changed so that openings in the cardboard boxes B face up, and the case-sealing section 33 where the openings in cardboard boxes B that have finished being packed with goods G are closed as the cardboard boxes B are conveyed.

(4-1) Goods-Receiving Section 31

In the goods-receiving section 31, cardboard boxes B are maintained in the first orientation and made to stand by with the openings thereof opposing the insertion plate 235 in the goods-inserting section 23. The insertion plate 235 pushes N goods G that are in a standing state in the goods-inserting section 23 out toward the open face of a cardboard box B. This cardboard box B accordingly stands by at this position in the goods-receiving section 31 until these N goods G are completely inserted through the opening in the cardboard box B toward the bottom thereof.

When a first layer of N goods G has been inserted into a cardboard box B, the cardboard box B is lowered a prescribed distance. Then, in order to receive a second layer of N goods G, a portion of the opening in the cardboard box B where there is space above the first layer is made to oppose the insertion plate 235, and the cardboard box B is made to stand by.

Repeating the operation described above, an ith layer of N goods G is inserted into the cardboard box B, and the reception of goods into the cardboard box B is finished.

(4-2) Second Orientation-Changing Section 32

As illustrated in FIG. 2B, the second orientation-changing section 32 has an orientation-changing mechanism 321 that changes the orientation of cardboard boxes B that have been packed with goods G to an orientation in which the opening is facing up.

The orientation-changing mechanism 321 sets open faces, which had been vertical until that point, so as to be horizontal. That is to say, the orientation-changing mechanism 321 rotates cardboard boxes B so that open faces thereof face up. The orientation-changing mechanism 321 holds a side face and a bottom face of a cardboard box B with an L-shaped member equipped with a suction pad that simultaneously adheres to a side face and a bottom face of the cardboard box B, and the cardboard box B is rotated by rotating the L-shaped member 90°.

(4-3) Case-Sealing Section 33

As illustrated in FIG. 2B, the case-sealing section 33 has a discharge conveyor 330 that conveys cardboard boxes B, a flap-closing mechanism (not illustrated) that closes the flaps surrounding the openings in cardboard boxes B, and a taping machine 380 that seals openings closed off by flaps.

(5) Detailed Configuration of Case-Forming Section 12

The following description will focus on an operation that folds the bottom flaps Zfb of a cardboard box precursor Z that has been expanded into a tubular shape.

(5-1) Bottom Flaps Zfb of Cardboard Boxes B

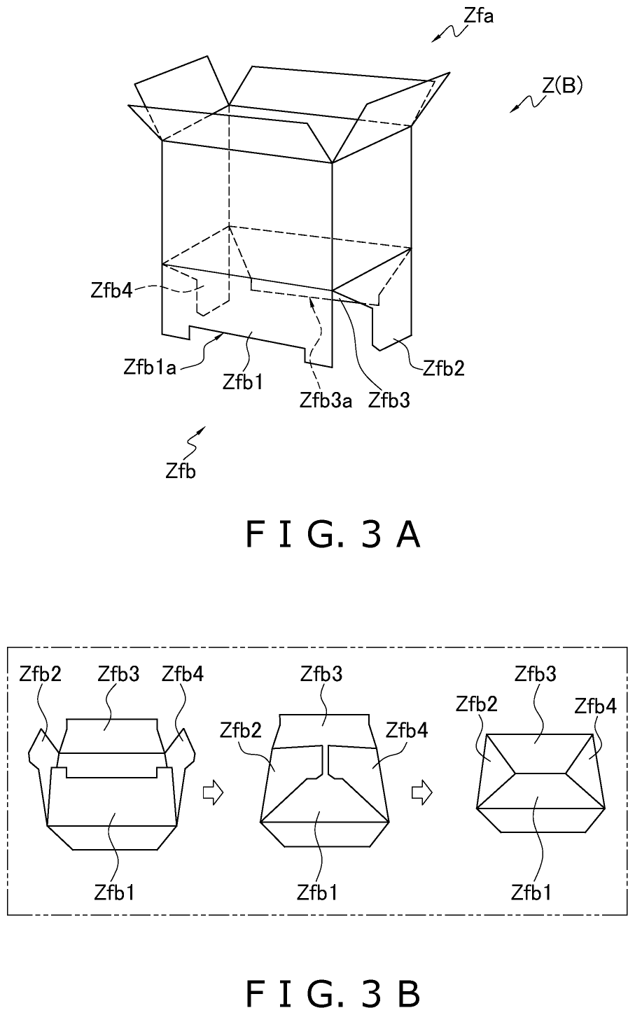

To begin, before describing this operation, the cardboard boxes B handled by the box-packing system 1 will be described. FIG. 3A is a perspective view of a cardboard box precursor Z that has been expanded into a tubular shape before folding bottom flaps Zfb. FIG. 3B is a perspective view displaying, in three stages, a process for folding the bottom flaps Zfb in FIG. 3A.

The bottom flaps Zfb in FIGS. 3A and 3B include a pair of large flaps Zfb1, Zfb3 that are mutually opposite to one another, and a pair of small flaps Zfb2, Zfb4 that are mutually opposite to one another.

A recessed cutout Zfb1a is provided in one large flap Zfb1 of the pair of large flaps Zfb1, Zfb3, and a protruding tab Zfb3a is provided to the other large flap Zfb3. To facilitate explanation, the large flap Zfb1 that has the recessed cutout Zfba1 is referred to as a large leading flap Zfb1, and the large flap that has the protruding tab Zfb3a is referred to as a large locking flap Zfb3.

FIG. 3B is a perspective view illustrating a sequence for folding the bottom flaps Zfb of a cardboard box B that has bottom flaps Zfb facing up. To fold the bottom flaps Zfb in FIG. 3B, first the large leading flap Zfb1 is folded, then the pair of small flaps Zfb2, Zfb4 are folded, and lastly, the large locking flap Zfb3 is folded. At such time, the large locking flap Zfb3 is pushed into the cardboard box B, the protruding tab Zfb3a passes through the recessed cutout Zfb1a in the large leading flap Zfb1, and the protruding tab Zfb3a strikes an inside face of the large leading flap Zfb1 and comes to a stop. The four bottom flaps Zfb thereby mutually interfering with one another and are locked in place.

Folding of the bottom flaps Zfb is performed automatically in the case-forming section 12. The bottom flap Zfb folding operation will now be described.

(5-2) Bottom Flap Zfb Folding Mechanism

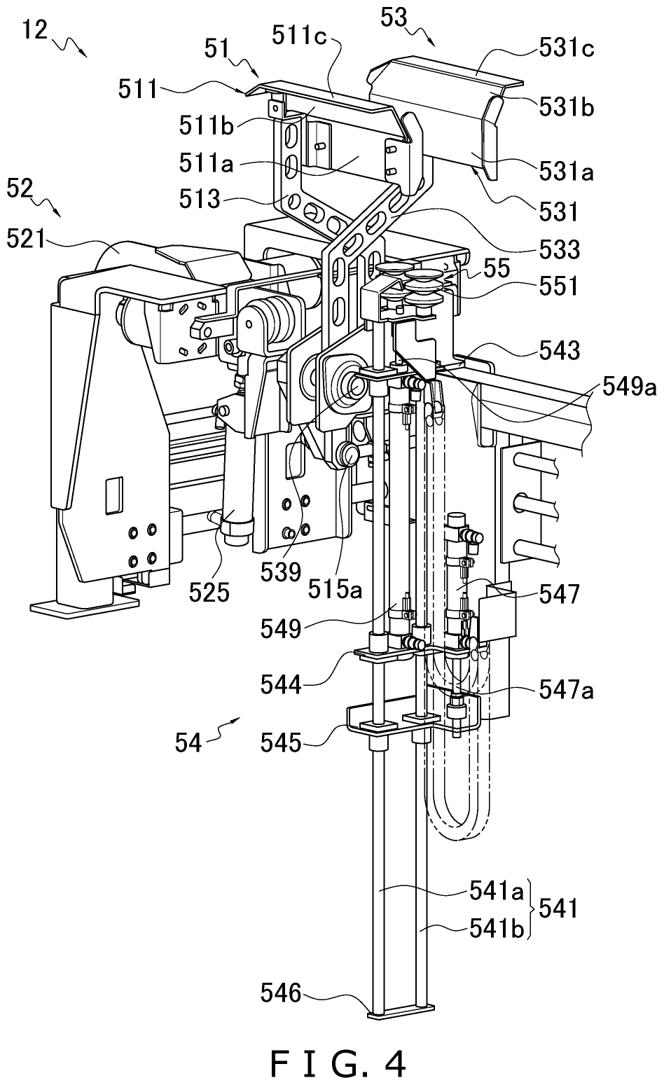

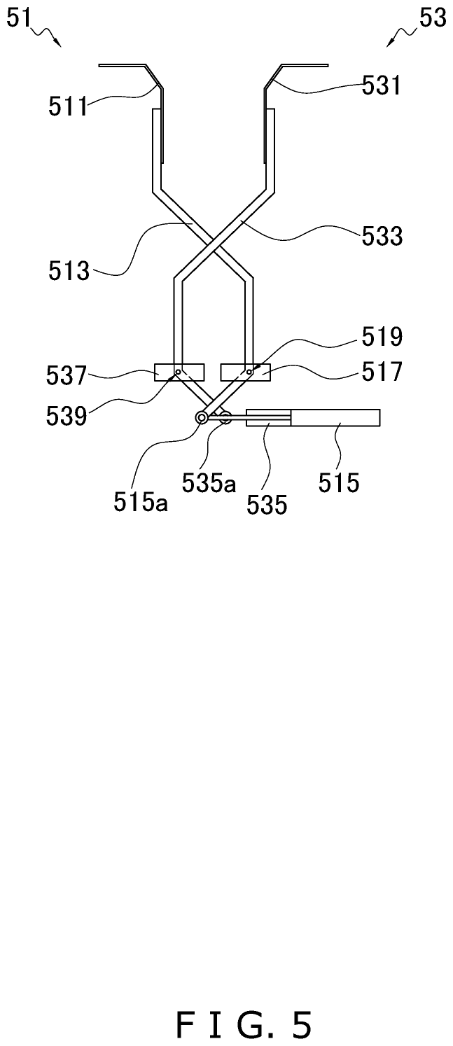

FIG. 4 is a perspective view of relevant parts of the case-forming section 12. FIG. 5 is a schematic side view of a first folding mechanism 51 and a third folding mechanism 53. The case-forming section 12 in FIGS. 4 and 5, which functions as the cardboard box assembly device, includes the first folding mechanism 51, a second folding mechanism 52, the third folding mechanism 53, a pushing mechanism 54, and a suction mechanism 55.

(5-2-1) First Folding Mechanism 51

The first folding mechanism 51 folds the large leading flap Zfb1, and as illustrated in FIG. 5, includes a first folding plate 511, a first coupling rod 513, and a first air cylinder 515.

(5-2-1-1) First Folding Plate 511

The first folding plate 511 is a metal plate member that has a first face 511a, a second face 511b, and a third face 511c.

The second face 511b extends from an end of the first face 511a at an obtuse angle with respect to the first face 511a. The third face 511c extends perpendicularly to the first face 511a from an end of the second face 511b. Thus, the third face 511c is vertically oriented when the first face 511a is horizontal, and the third face 511c is horizontal when the first face 511a is vertical.

(5-2-1-2) First Coupling Rod 513

The first coupling rod 513 transmits piston displacement of the first air cylinder 515 to the first folding plate 511.

One end of the first coupling rod 513 is secured to a rear side of the first face 511a of the first folding plate 511. The rear side of the first face 511a is on the opposite side of the first face 511a to a side thereof that strikes a large leading flap Zfb1 when folding the large leading flap Zfb1.

As illustrated in FIG. 5, another end of the first coupling rod 513 is connected to a leading end of a piston 515a of the first air cylinder 515. A rotary shaft 519 that is supported by a bearing 517 is coupled to a section of the first coupling rod 513. The first coupling rod 513 thus pivots about the rotary shaft 519 due to the piston 515a traveling back and forth, and the first folding plate 511 swings in accordance therewith.

(5-2-2) Second Folding Mechanism 52

The second folding mechanism 52 includes a pair of second folding plates 521 that are opposite to one another, and second air cylinders 525 that respectively cause the pair of second folding plates 521 to pivot.

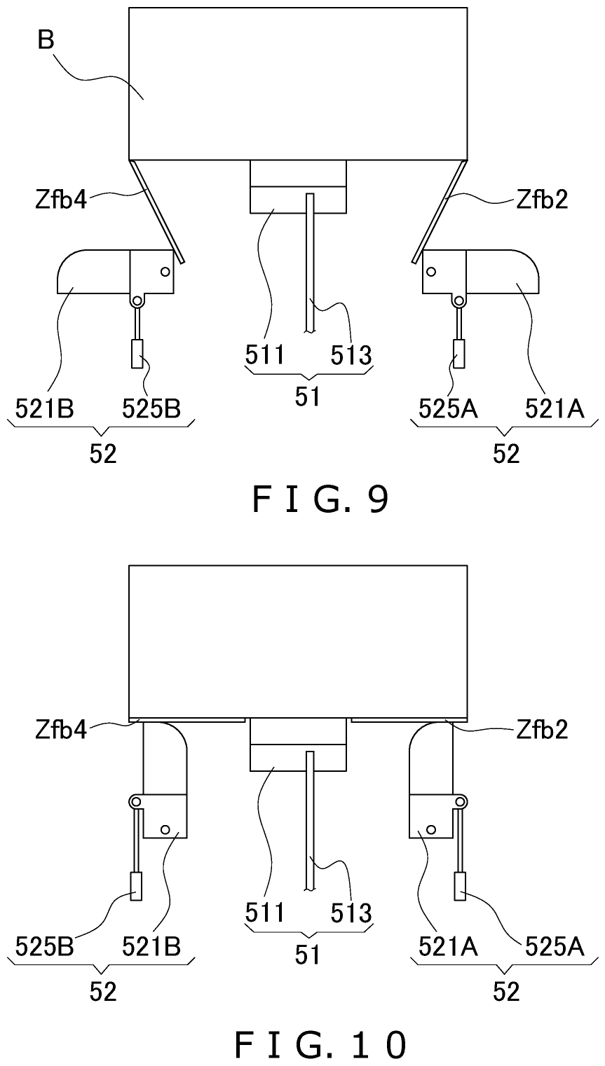

To facilitate explanation, the second folding plate 521 that folds the small flap Zfb2 is referred to as a second folding plate 521A, and the second folding plate 521 that folds the small flap Zfb4 is referred to as a second folding plate 521B (see FIGS. 9 and 10).

The air cylinder that causes the second folding plate 521A to pivot is referred to as a second air cylinder 525A, and the air cylinder that causes the second folding plate 521B to pivot is referred to as a second air cylinder 525B.

The second folding plate 521A is a metal plate member that has a quarter-circle arc. A pivot shaft is provided thereto at a position a prescribed distance away from this quarter-circle arc. A leading end of a piston of the second air cylinder 525A is coupled to between the quarter-circle arc and the pivot shaft. Due to the piston of the second air cylinder 525A traveling back and forth, the second folding plate 521A pivots, and the quarter-circle arc folds the small flap Zfb2.

The second folding plate 521B is also a metal plate member that has a quarter-circle arc. The second folding plate 521B has the same shape as a mirror image of the second folding plate 521A, and a pivot shaft is provided thereto at a position a prescribed distance away from this quarter-circle arc. A leading end of a piston of the second air cylinder 525B is coupled to between the quarter-circle arc and the pivot shaft. Due to the piston of the second air cylinder 525B traveling back and forth, the second folding plate 521B pivots, and the quarter-circle arc folds the small flap Zfb4.

(5-2-3) Third Folding Mechanism 53

The third folding mechanism 53 folds the large locking flap Zfb3, and as illustrated in FIG. 5, includes a third folding plate 531, a third coupling rod 533, and a third air cylinder 535. Although the positions of the third air cylinder 535, the third folding plate 531, and the third coupling rod 533 are not visible in FIG. 4, these are shown in the schematic side view of the third folding mechanism 53 in FIG. 5. Refer to FIG. 5 as needed.

(5-2-3-1) Third Folding Plate 531

The third folding plate 531 is a metal plate member that has a first face 531a, a second face 531b, and a third face 531c.

The second face 531b extends from an end of the first face 531a at an obtuse angle with respect to the first face 531a. The third face 531c extends perpendicularly to the first face 531a from an end of the second face 531b. Thus, the third face 531a is vertically oriented when the first face 531a is horizontal, and the third face 531c is horizontal when the first face 531a is vertical.

(5-2-3-2) Third Coupling Rod 533

The third coupling rod 533 transmits piston displacement of the third air cylinder 535 to the third folding plate 531.

One end of the third coupling rod 533 is secured to a rear side of the first face 531a of the third folding plate 531. The rear side of the first face 531a is on the opposite side of the first face 531a to a side thereof that strikes the large locking flap Zfb3 when folding the large locking flap Zfb3.

As illustrated in FIG. 5, another end of the third coupling rod 533 is connected to a leading end of a piston 535a of the third air cylinder 535. A rotary shaft 539 that is supported by a bearing 537 is coupled to a section of the third coupling rod 533. The third coupling rod 533 thus pivots about the rotary shaft 539 due to the piston 535a traveling back and forth, and the third folding plate 531 swings in accordance therewith.

(5-2-4) Pushing Mechanism 54

As described under “(5-1) Bottom flaps Zfb of cardboard boxes B,” the large locking flap Zfb3 is pushed into the cardboard box B, the convex protruding tab Zfb3a passes through the recessed cutout Zfb1a in the large leading flap Zfb1, and the protruding tab Zfb3a is overlapped with the inside face of the large leading flap Zfb1.

The pushing mechanism 54 therefore has a pushing rod 541 that pushes the large locking flap Zfb3 into the cardboard box B.

(5-2-4-1) Pushing Rod 541

As illustrated in FIG. 4, the pushing rod 541 is made of two pushing rods 541a, 541b. In order to maintain a uniform spacing therebetween, the two pushing rods 541a, 541b are supported by an upper holding plate 543, a guide plate 544, an intermediate holding plate 545, and a lower holding plate 546.

These four plate members are disposed, from the top, in the following order: the upper holding plate 543, the guide plate 544, the intermediate holding plate 545, and the lower holding plate 546. Two through-holes through which the two pushing rods 541a, 541b pass are provided in the upper holding plate 543, the guide plate 544, the intermediate holding plate 545, and the lower holding plate 546.

Pitches between the two respective through-holes in the upper holding plate 543, the guide plate 544, the intermediate holding plate 545, and the lower holding plate 546 are matched such that a uniform spacing can be maintained between the two pushing rods 541a, 541b.

The two pushing rods 541a, 541b and the two respective through-holes in the upper holding plate 543, the intermediate holding plate 545, and the lower holding plate 546, are secured together.

The two pushing rods 541a, 541b and the two through-holes in the guide plate 544 are provided with clearances such that the two pushing rods 541a, 541b are capable of sliding therethrough. This enables relative movement between the two pushing rods 541a, 541b and the two through-holes in the guide plate 544.

A head 541c having a suction pad 551 that makes direct contact with the large locking flap Zfb3 is supported at a leading end of the pushing rod 541. The head 541c is a metal plate member shaped by bending a single piece of metal. The head 541c has an L-shape in cross-section.

(5-2-4-2) First Pushing Air Cylinder 547

A first pushing air cylinder 547 is disposed oriented with a piston 547a directed vertically downward. A leading end part of the piston 547a is coupled to the intermediate holding plate 545. Due to the piston 547a moving back and forth along an up-down direction, the pushing rod 541 and the head 541c move along the up-down direction.

(5-2-4-3) Second Pushing Air Cylinder 549

A second pushing air cylinder 549 is disposed oriented with a piston 549a directed vertically upward. A leading end part of the piston 549a is coupled to the head 541c. A lower face of the head 541c is coupled to two second pushing rods (not illustrated) that are at the same pitch as the two pushing rods 541a, 541b.

The two pushing rods 541a, 541b are hollow cylinders, and the two second pushing rods have outer diameters that are slightly smaller than inner diameters of these hollow cylinders. One of the second pushing rods is inserted into the hollow cylinder of the pushing rod 541a, and the other of the two pushing rods is inserted into the hollow cylinder of the pushing rod 541b.

Thus, only the head 541c moves along the up-down direction due to the piston 549a moving back and forth along the up-down direction.

(5-2-5) Suction Mechanism 55

The suction mechanism 55 is provided at an upper face of the head 541c of the pushing rod 541. The suction mechanism 55 has, at a minimum, the suction pad 551. The suction pad 551 adheres to a surface of a large locking flap Zfb3 when the large locking flap Zfb3 is pushed into a cardboard box B, and in a process in which the head 541c returns to a stand-by position, pulls the large locking flap Zfb3 back from a position to which the large locking flap Zfb3 was pushed to a position of the bottom face of the cardboard box B.

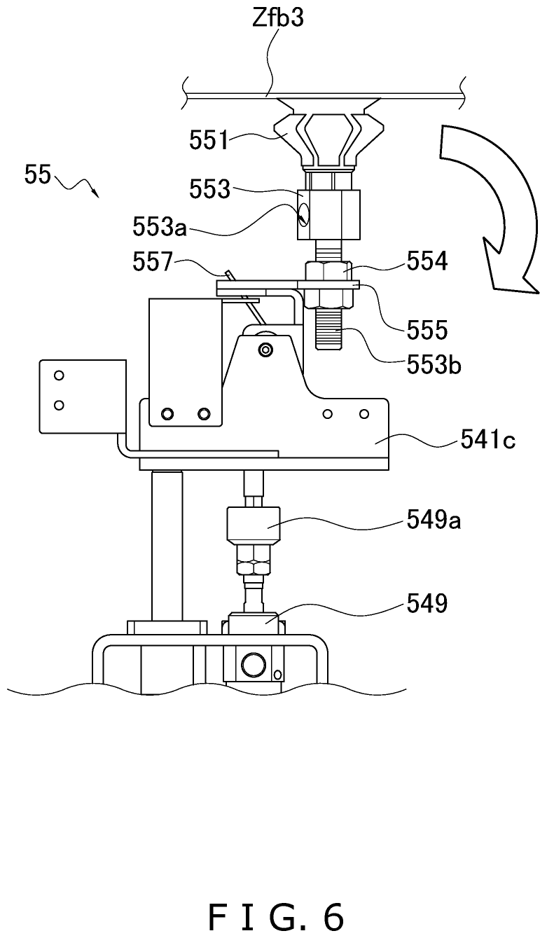

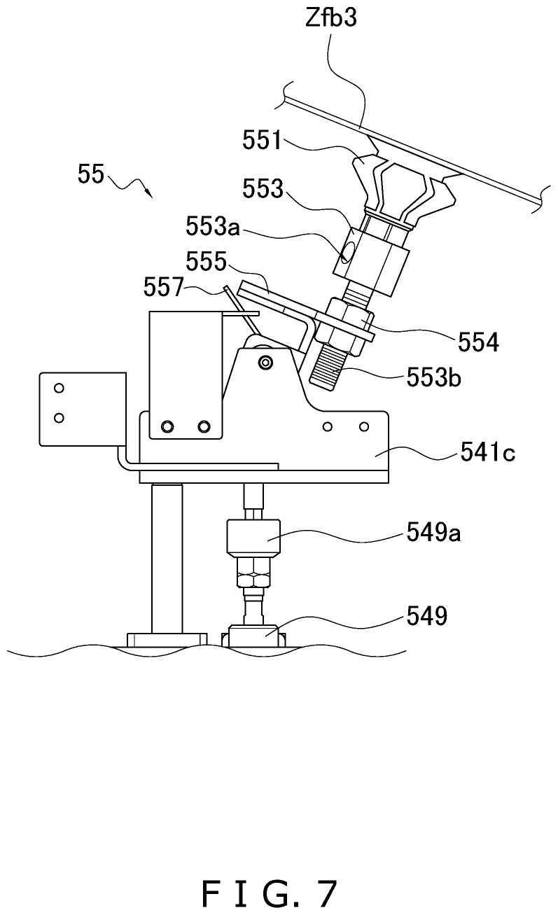

FIG. 6 is a side view of the suction pad 551 immediately before the suction pad 551 strikes a large locking flap Zfb3. FIG. 7 is a side view of the suction pad 551 when the suction pad 551 has struck a large locking flap Zfb3 and pushed in the large locking flap Zfb3.

The suction mechanism 55 in FIG. 6 includes the suction pad 551, a connector 553, a connector holding plate 555, and an orientation control spring 557.

The suction pad 551 is, for example, a bellow-form member that is formed from silicon rubber. The connector 553 is connected to the suction pad 551 on the opposite side of the suction pad 551 to an adhering face. A body of the connector 553 is hollow. A connection hole 553a, to which a suction tube (not illustrated) is connected, is provided in a side face of the body of the connector 553.

A bolt 553b, this being a threaded part, is also provided to the connector 553. The connector 553 is secured to the connector holding plate 555 by the bolt 553b and a nut 554.

The connector holding plate 555 is rotatably held by the head 541c. The orientation control spring 557 is a twisted coil spring. One end of the orientation control spring 557 is hooked onto the connector holding plate 555, and another end of the orientation control spring 557 is hooked onto the head 541c.

When standing by, the suction pad 551 takes on an orientation in which the adhering face is directed vertically upward. As illustrated in FIG. 7, the adhering face of the suction pad 551 adopts an incline keeping with change in an inclination angle of the large locking flap Zfb3 when the large locking flap Zfb3 is pushed in. At such time, angular displacement of the adhering face of the suction pad 551 is transmitted to the connector holding plate 555 via the connector 553, and the connector holding plate 555 undergoes angular displacement against biasing force from the orientation control spring 557.

(6) Operation of Case-Forming Section 12

Operation of the case-forming section 12, which functions as the cardboard box assembly device, will now be described. In particular, operation of the first folding plate 511, the second folding plates 521A, 521B, and the third folding plate 531 will be described with reference to the flowchart.

(Step S1)

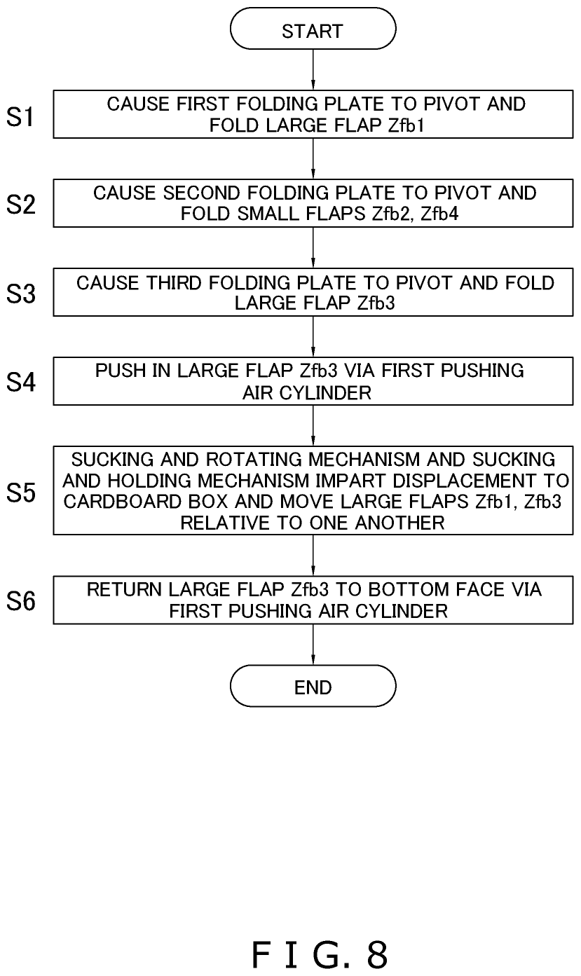

FIG. 8 is a flowchart of operation of the case-forming section 12. In FIG. 8, the controller 40 causes the first folding plate 511 to pivot and fold the large leading flap Zfb1. This folding angle is approximately 90°.

FIG. 9 is a side view of a cardboard box B after a large leading flap Zfb1 has been folded and immediately before small flaps Zfb2, Zfb4 are folded.

In FIG. 9, the first folding plate 511 has first folded the large leading flap Zfb1 and is standing by. At such time, the set of small flaps Zfb2, Zfb4 are in a state waiting to be folded by the second folding plates 521A, 521B.

(Step S2)

Next, in step S2, the controller 40 causes the second folding plates 521A, 521B to pivot and fold the small flaps Zfb2, Zfb4. These folding angles are approximately 90°.

FIG. 10 is a side view of a cardboard box B after small flaps Zfb2, Zfb4 have been folded. In FIG. 10, the pistons of the second air cylinders 525A, 525B are raised, and the second folding plates 521A, 521B are caused to pivot approximately 90°, whereby the small flaps Zfb2, Zfb4 are folded.

(Step S3)

Next, in step S3, the controller 40 causes the third folding plate 531 to pivot and fold the large locking flap Zfb3. This folding angle is approximately 90°.

(Step S4)

Next, in step S4, the controller 40 causes the piston 547a of the first pushing air cylinder 547 to move vertically upward, then causes the second pushing air cylinder 549 to actuate and push the large locking flap Zfb3 inside the cardboard box B.

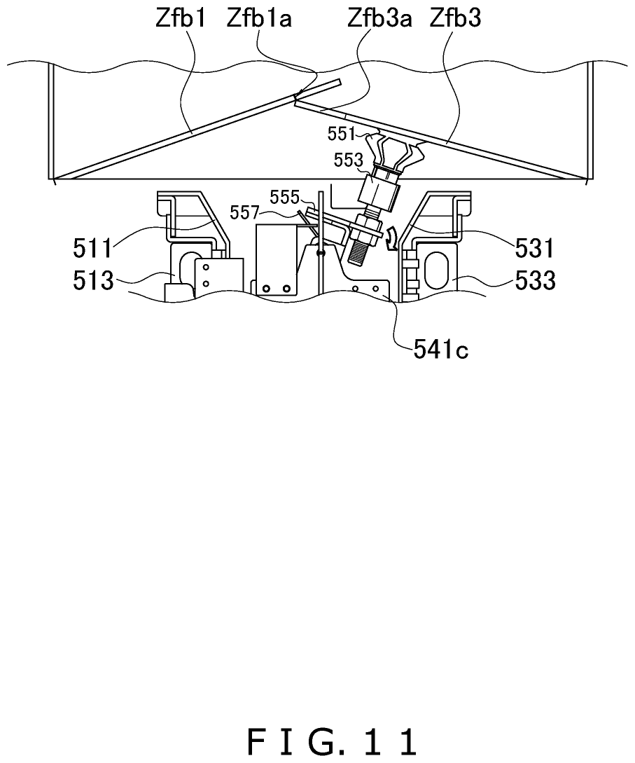

FIG. 11 is a front view of a cardboard box B when the third folding plate 531 has folded a large locking flap Zfb3 and the head 541c has been raised. In FIG. 11, as a result of head 541c being raised, the suction pad 551 pushes the large locking flap Zfb3 inside the cardboard box B, the large locking flap Zfb3 pivots about a base thereof, and the large locking flap Zfb3 adopts an incline.

The large locking flap Zfb3 is pushed in until the protruding tab Zfb3a of the large locking flap Zfb3 gets over the cutout Zfb1a in the large leading flap Zfb1 and rides above the inside face of the large leading flap Zfb1.

At such time, the adhering face of the suction pad 551 adopts an incline keeping with change in the inclination angle of the large locking flap Zfb3. Angular displacement of the adhering face of the suction pad 551 is transmitted to the connector holding plate 555 via the connector 553, and the connector holding plate 555 undergoes angular displacement against biasing force from the orientation control spring 557.

(Step S5)

Next, in step S5, the controller 40 causes the cardboard box B to move a fixed distance back and forth along the direction of conveyance and imparts a displacement to the cardboard box B.

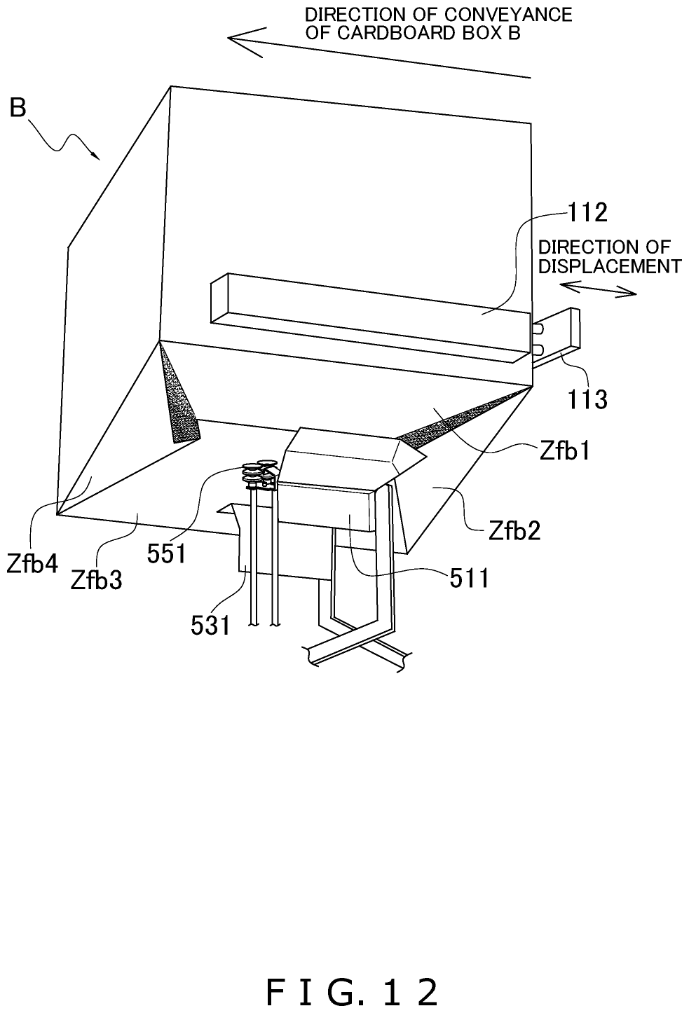

FIG. 12 is a perspective view of a cardboard box B when a large locking flap Zfb3 has been pushed inside the cardboard box B. In FIG. 12, the large locking flap Zfb3 is held stationary in a state adhered by the suction pad 551.

At such time, the protruding tab Zfb3a of the large locking flap Zfb3 clears the cutout Zfb1a in the large leading flap Zfb1 and rides above the inside face of the large leading flap Zfb1. In this state, when the sucking and rotating mechanism 112 and a sucking and holding mechanism 113, which hold cardboard boxes B with a suction cup, move the cardboard box B a fixed distance back and forth along the direction of conveyance, the cardboard box B is displaced, and the large leading flap Zfb1 and the large locking flap Zfb3 move relative to one another.

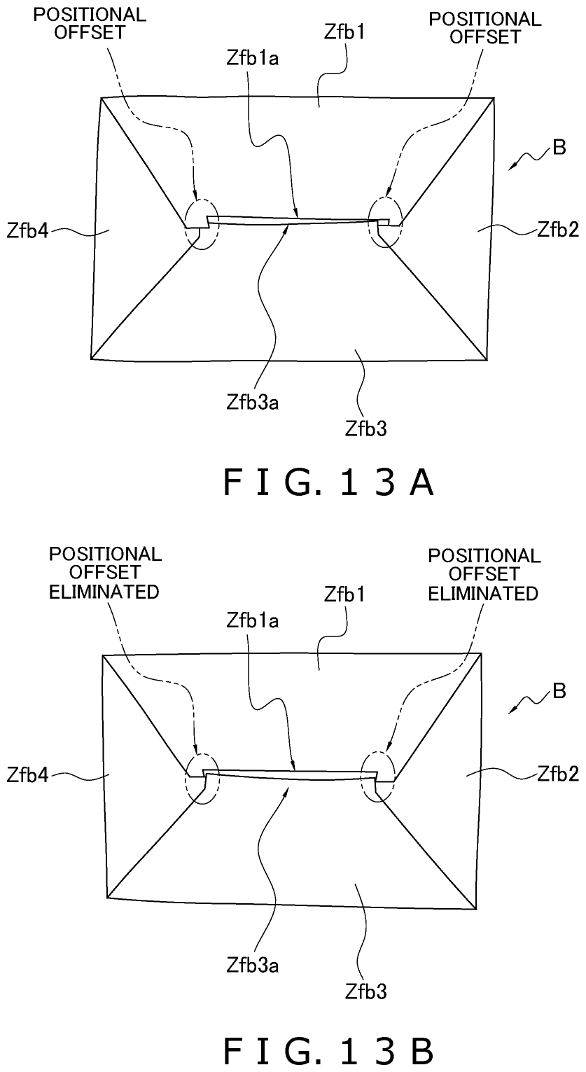

FIG. 13A is a perspective view of a cardboard box B after the large locking flap Zfb3 has been pushed inside the cardboard box B but before the large leading flap Zfb1 and the large locking flap Zfb3 move relative to one another.

FIG. 13B is a perspective view of a cardboard box B after the large locking flap Zfb3 has been pushed inside the cardboard box B and after the large leading flap Zfb1 and the large locking flap Zfb3 move relative to one another.

In FIGS. 13A and 13B, even in cases in which the protruding tab Zfb3a of the large locking flap Zfb3 is not engaged with the cutout Zfb1a in the large leading flap Zfb1 (see FIG. 13A), due to the large leading flap Zfb1 and the large locking flap Zfb3 moving relative to one another, the protruding tab Zfb3a can be placed into the cutout Zfb1a, and the protruding tab Zfb3a and the cutout Zfb1a can mutually engage with one another (see FIG. 13B).

Ideally, it is desirable that operation of the sucking and rotating mechanism 112 and the sucking and holding mechanism 113 is operation such that after imparting a displacement that deforms a shape of the opening in a cardboard box B in plan view into a parallelogram shape, a displacement is imparted that restores the opening to an original shape thereof.

(Step S6)

Next, in step S6, the controller 40 causes the piston 547a of the first pushing air cylinder 547 to move vertically downward and return the large locking flap Zfb3 to a bottom face level.

The head 541c is lowered by moving the piston 547a of the first pushing air cylinder 547 vertically downward.

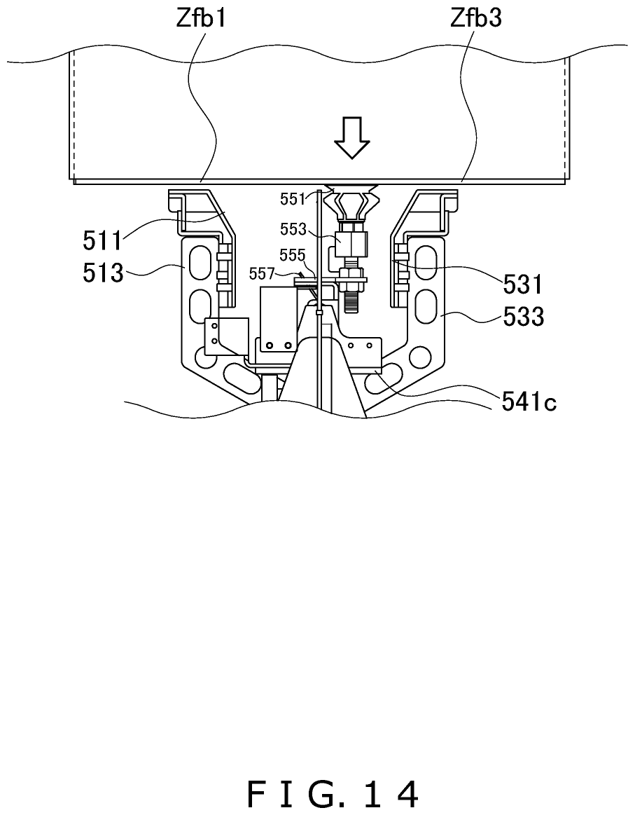

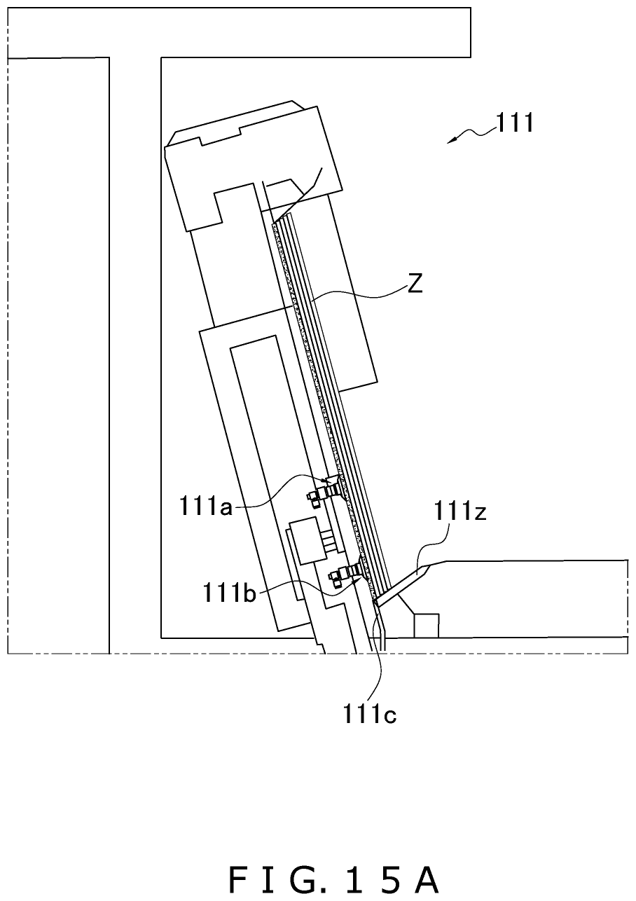

FIG. 14 is a front view of a cardboard box B when the head 541c has been lowered and the large locking flap Zfb3 has been returned to the original bottom face level. In FIG. 14, accompanying lowering of the head 541c, the suction pad 551 is also lowered. Because the suction pad 551 is lowered in a state adhering the surface of the large locking flap Zfb3, the large locking flap Zfb3 does not stay inside the cardboard box B, but is pulled back to a position at a height of the bottom face of the cardboard box B.

The protruding tab Zfb3a of the large locking flap Zfb3 clears the cutout Zfb1a in the large leading flap Zfb1, the protruding tab Zfb3a of the large locking flap Zfb3 rides above the inside face of the large leading flap Zfb1, and the protruding tab Zfb3a of the large locking flap Zfb3 and the cutout Zfb1a in the large leading flap Zfb1 are engaged with one another in a stage before the large locking flap Zfb3 is pulled back to the position at the height of the bottom face of the cardboard box B. Because the large locking flap Zfb3 is lowered so as to pin down the large leading flap Zfb1, the large leading flap Zfb1 and the large locking flap Zfb3 are lowered in this order to the position of the height of the bottom face.

As described above, even in cases in which the protruding tab Zfb3a of the large locking flap Zfb3 and the cutout Zfb1a of the large leading flap Zfb1 are not engaged with one another, because the sucking and rotating mechanism 112 and the sucking and holding mechanism 113 impart a prescribed displacement to the cardboard box B whereby the large leading flap Zfb1 and the large locking flap Zfb3 move relative to one another, positional offset is eliminated, and the protruding tab Zfb3a and the cutout Zfb1a engage with one another.

The bottom of the cardboard box B will assume a state in which the large leading flap Zfb1, the large locking flap Zfb3, and the pair of small flaps Zfb2, Zfb4 mutually interfere with one another, and the bottom of the cardboard box B will be completed.

The large locking flap Zfb3 also pivots about the base thereof when lowered. As such, the large locking flap Zfb3 is lowered as inclination angle changes, and change in the inclination angle of the adhering face of the suction pad 551 is transmitted to the connector holding plate 555 via the connector 553. Because the connector holding plate 555 is biased by the orientation control spring 557, the connector holding plate 555 is able to follow change in the inclination angle of the adhering face of the suction pad 551.

The adhering face of the suction pad 551 is therefore able to follow change in the inclination angle of the large locking flap Zfb3, and secure adhering is able to be maintained.

At a timing that the adhering face of the suction pad 551 reaches the position at the height of the bottom face of the cardboard box B, suction by the suction pad 551 is released, the head 541c is lowered further, and the suction pad 551 is moved away from the large locking flap Zfb3.

(7) Features

(7-1)

In the case-forming section 12, which functions as the cardboard box assembly device, when the head 541c of the pushing mechanism 54 pushes in a large locking flap Zfb3, the sucking and rotating mechanism 112 and the sucking and holding mechanism 113 impart a prescribed displacement to a cardboard box B, whereby a large leading flap Zfb1 and the large locking flap Zfb3 move relative to one another. As a result, positional offset is eliminated, and the protruding tab Zfb3a and the cutout Zfb1a engage with one another.

Herein, “when the head 541c of the pushing mechanism 54 pushes in the large locking flap Zfb3” encompasses times when the head 541c of the pushing mechanism 54 is performing an operation to push in the large locking flap Zfb3, and times when the head 541c of the pushing mechanism 54 is maintaining a state in which the large locking flap Zfb3 has been pushed in.

(7-2)

The large leading flap Zfb1 and the large locking flap Zfb3 move relative to one another along a direction intersecting the direction in which the large locking flap Zfb3 is pushed.

(7-3)

The sucking and rotating mechanism 112 and the sucking and holding mechanism 113 make contact with a flap other than the large locking flap Zfb3, or with a side face of the cardboard box B, and impart displacement to the cardboard box B, whereby the shape of the opening thereof in plan view is able to be distorted. As a result, the large leading flap Zfb1 and the large locking flap Zfb3 are able to be moved relative to one another along the direction intersecting the direction in which the large locking flap Zfb3 is pushed.

(7-4)

The sucking and rotating mechanism 112 and the sucking and holding mechanism 113 hold and move a cardboard box B when the cardboard box B is conveyed. When the head 541c of the pushing mechanism 54 pushes in the large locking flap Zfb3, the sucking and rotating mechanism 112 and the sucking and holding mechanism 113 move the cardboard box B back and forth along the direction of conveyance, whereby the large leading flap Zfb1 moves relative to the large locking flap Zfb3, the movement of which is restricted by the suction pad 551.

(8) Modifications

In the above embodiment, configuration is such that the large leading flap Zfb1 moves relative to the large locking flap Zfb3, the movement of which is restricted by the suction pad 551. However, there is no limitation thereto.

For example, the pushing mechanism 54 can impart, to the large locking flap Zfb3, displacement in a direction intersecting the direction in which the large locking flap Zfb3 is pushed. In such case, instead of the sucking and rotating mechanism 112 and the sucking and holding mechanism 113 imparting a displacement to a cardboard box B, the pushing mechanism 54 would impart a displacement to the large locking flap Zfb3 in the direction intersecting the direction in which the large locking flap Zfb3 is pushed while the sucking and rotating mechanism 112 and the sucking and holding mechanism 113 remain stationary, whereby the large locking flap Zfb3 would move relative to the large leading flap Zfb1.

(9) Other Configuration

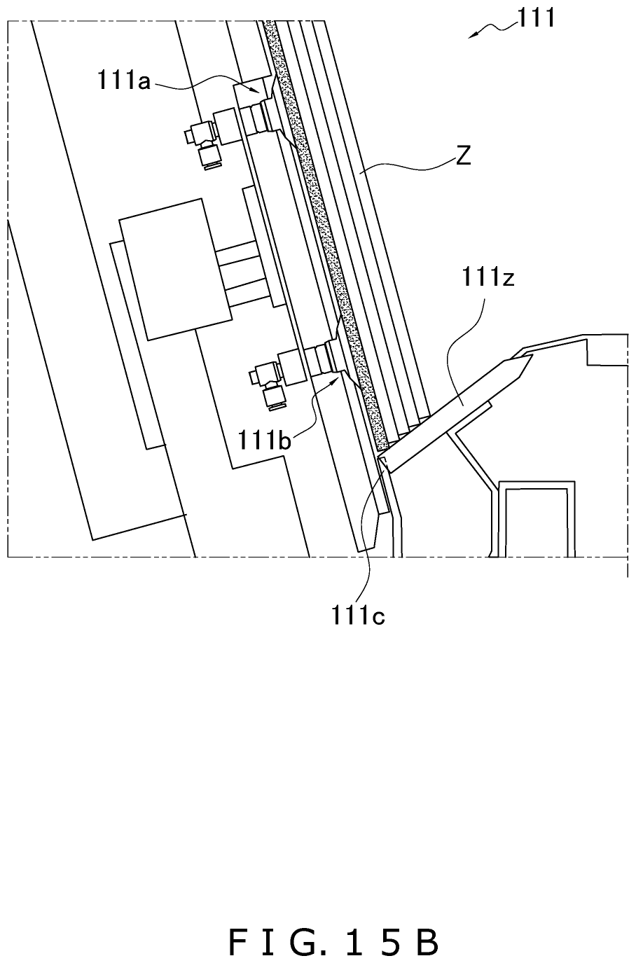

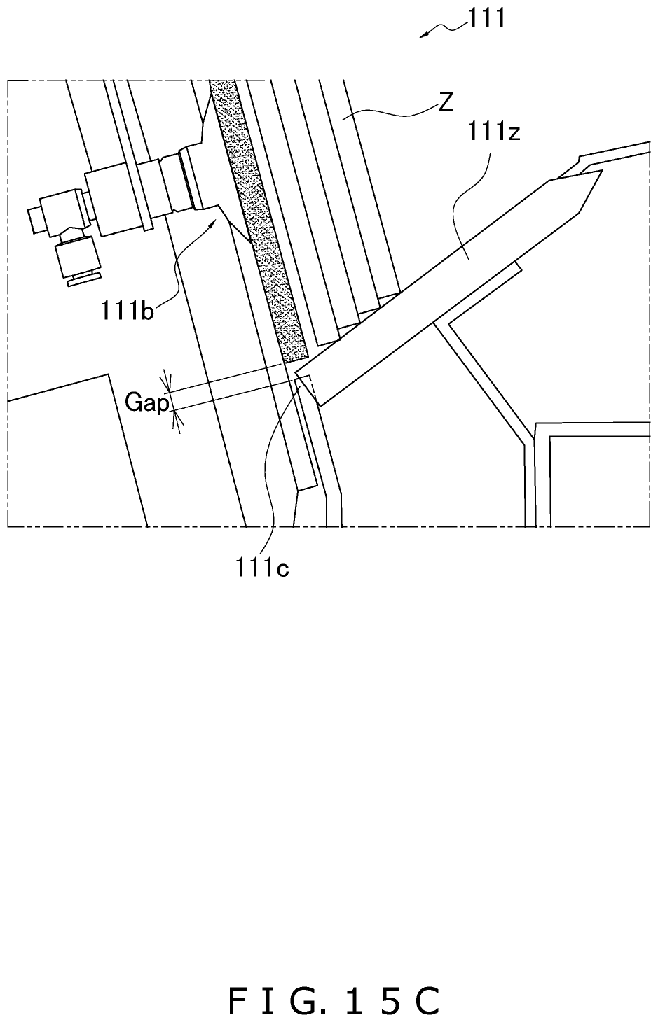

FIG. 15A is a side view of the lifting mechanism 111 before dispensing a sheet-form cardboard box precursor Z upward. The lifting mechanism 111 in FIG. 15A has a set of suction cups 111a, 111b, and a lifting pick 111c. The set of suction cups 111a, 111b adhere to a lower part of the nearest cardboard box precursor Z (the hatched portion in the drawings) of the group of sheet-form cardboard box precursors Z stacked in an inclined state, and separate this cardboard box precursor Z from the group of cardboard box precursors Z.

FIG. 15B is an enlarged side view of relevant parts of the lifting mechanism 111 immediately before the suction cups 111a, 111b adhere to a cardboard box precursor Z. FIG. 15C is an enlarged side view of relevant parts of the lifting mechanism 111 immediately after the suction cups 111a, 111b adhere to a cardboard box precursor Z.

In FIGS. 15B and 15C, a support platform 111z that supports lower ends of the sheet-form cardboard box precursors Z (hereafter referred to as “sheets”) is inclined, and because of this, when the suction cups 111a, 111b adhere to the front sheet and draw the front sheet closer, as illustrated in FIG. 15C, a gap Gap arises between the lower end of the sheet that has been drawn closer and the lifting pick 111c. There are also cases in which lower ends of sheets are loaded on the support platform 111z in a state lifted off the support platform 111z. Thus, when such sheets are adhered, an even wider gap Gap will arise.

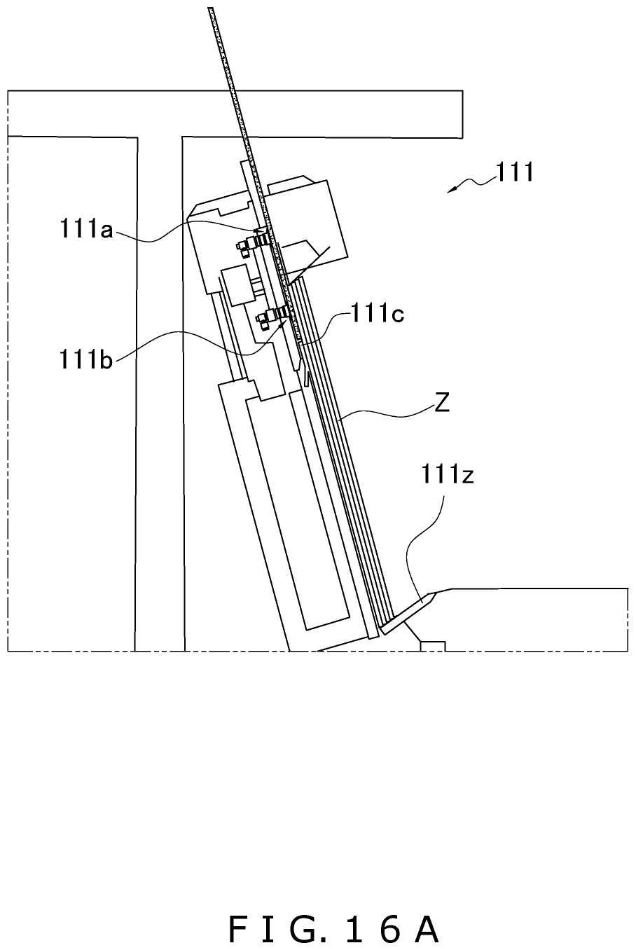

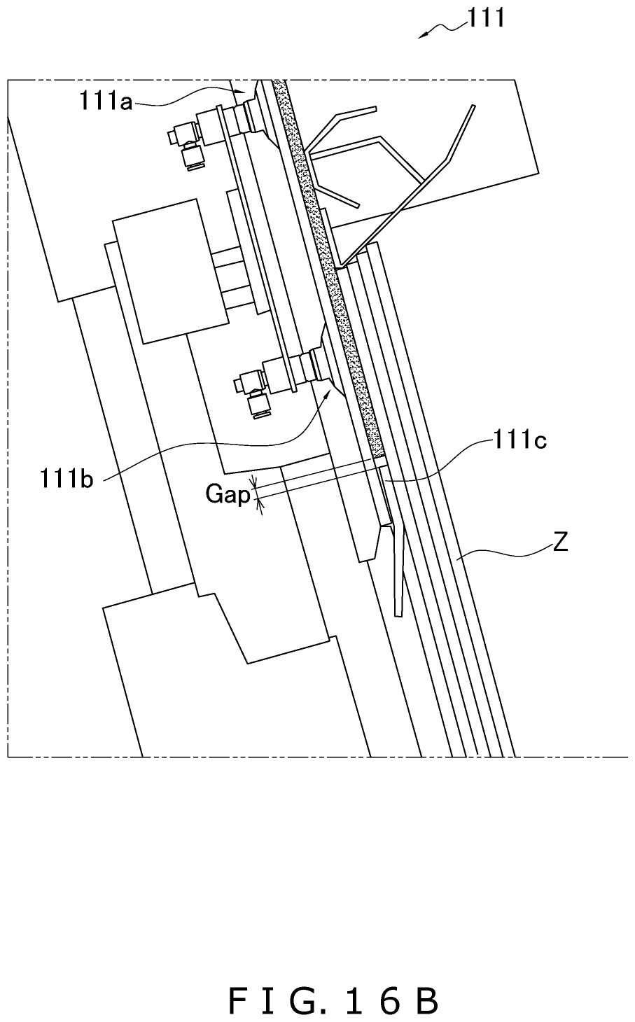

FIG. 16A is a side view of the lifting mechanism 111 after dispensing a sheet-form cardboard box precursor Z upward. In FIG. 16A, a sheet is raised upward to the case-forming section thereabove in a state adhered by the suction cups 111a, 111b. Although the sheet is freed from adhering by the suction cups 111a, 111b at the point in time at which the sheet finishes being raised, the sheet is held in the raised position by pressure from the group of other sheets.

FIG. 16B is an enlarged side view of an area around the suction cups 111a, 111b after a sheet-form cardboard box precursor Z has been dispensed upward and after the suction cups 111a, 111b have stopped adhering. In FIG. 16B, the sheet has been raised in a state in which a gap Gap is present between a lower end of the sheet and the lifting pick 111c, and due to the gap Gap having been maintained, a height of the sheet after being raised is changed. In this case, a state is reached in which the sheet cannot be passed to the case-forming section at a position at an appropriate height.

Accordingly, in the present embodiment, a configuration is adopted such that when a sheet is adhered by the suction cups 111a, 111b and raised while adhered, the sheet is freed from the adhering of the suction cups 111a, 111b before a target raised position (settable to any position within a range of 10-50 mm of).

The suction cups 111a, 111b, which are not adhering to anything, and the lifting pick 111c consequently strike the lower end of the sheet, the gap Gap between the lower end of the sheet and the lifting pick 111c is eliminated, and the sheet can be moved to the target raised position.

### REFERENCE SIGNS LIST

12 Case-forming section (cardboard box assembly device)
112 Sucking and rotating mechanism (drive unit)
113 Sucking and holding mechanism (drive unit)
51 First folding mechanism (folding unit)
52 Second folding mechanism (folding unit)
53 Third folding mechanism (folding unit)
54 Pushing mechanism (pushing unit)
541 Pushing rod (pushing unit)
541a Pushing rod (pushing unit)
541b Pushing rod (pushing unit)
541c Head (pushing unit)
551 Suction pad (pushing unit)
B Cardboard box
Zfb1 Large leading flap (other flap)
Zfb2 Small flap (other flap)
Zfb3 Large locking flap (locking flap)
Zfb4 Small flap (other flap)
Zfb1a Cutout (first unit)
Zfb3a Protruding tab (second unit)

What is claimed is:

1. A cardboard box assembly device that folds four flaps provided at edges of an opening in a cardboard box so as to surround the opening, the cardboard box assembly device comprising:
a folding unit configured to fold each of the four flaps in a prescribed sequence and close the opening;
a pushing unit configured to push one of the four flaps, that is folded last, inward into the cardboard box as a locking flap, and overlap the locking flap onto the other flaps; and
a drive unit configured to contact the cardboard box and impart a prescribed displacement to the cardboard box,
parts that engage with one another being formed between the locking flap and at least one of the other flaps, and
the drive unit being further configured to move the locking flap relative to the other flaps due to the displacement when the pushing unit pushes the locking flap.

2. The cardboard box assembly device according to claim 1, wherein the locking flap and the other flaps move relative to one another along a direction intersecting a direction in which the locking flap is pushed.

3. The cardboard box assembly device according to claim 1, wherein the drive unit is further configured to contact at least one of the flaps other than the locking flap, or a side face of the cardboard box, and impart the displacement to the cardboard box.

4. The cardboard box assembly device according to claim 1, further comprising
a holding unit configured to hold and move the cardboard box when the cardboard box is conveyed,
the holding unit being configured to serve as the drive unit.

5. The cardboard box assembly device according to claim 2, wherein the pushing unit is further configured to impart a displacement to the locking flap along the direction intersecting the direction in which the locking flap is pushed.

6. The cardboard box assembly device according to claim 1, wherein the drive unit is further configured to impart, after imparting a first displacement that deforms a shape of the opening of the cardboard box in plan view into a parallelogram shape, a second displacement that restores the opening to an original shape thereof.

7. The cardboard box assembly device according to claim 1, wherein one of the four flaps, opposing the locking flap, has a first part that is cut out into a recessed shape,
the locking flap has a second part that protrudes so as to be inserted into the first part, and
when the pushing unit pushes the locking flap, the second part is overlapped onto the first part.
